(19) United States
(12) Patent Application Publication
(10) Pub. No.: US 2006/0188722 A1
(43) Pub. Date: Aug. 24, 2006

(54) Colloidal particle sols, methods for preparing and curable film-forming compositions containing the same

(76) Inventors: Daniella White, Oswego, IL (US); Heather L. Eisaman, Pittsburgh, PA (US); Thomas R. Hockswender, Gibsonia, PA (US); Keith J. Serene, Lower Burrell, PA (US); Shiryn Tyebjee, Allison Park, PA (US); Jane N. Valenta, Pittsburgh, PA (US)

Correspondence Address: PPG INDUSTRIES, INC.;Law Dept. - Intellectual Property, One PPG Place, Pittsburgh, PA, 15272, US

(21) Appl. No.: 11/145,812

(22) Filed: Jun. 6, 2005

Related U.S. Application Data
(60) Provisional application No. 60/655,064, filed on Feb. 22, 2005.

(51) Int. Cl. B32B 5/16; C09B 67/00

(52) U.S. Cl. 428/403; 523/333

(57) ABSTRACT

Methods of preparing an organic sol of particles are provided. Steps include providing a suspension of particles in an aqueous medium; adding a first organic liquid compatible with the aqueous medium to form an admixture; reacting the particles with a first and a second modifying compound; adding a second organic liquid compatible with the liquid portion of the admixture wherein the second organic liquid is different from the first organic liquid; and maintaining the admixture at a temperature and pressure and for a time sufficient to substantially remove the water and the first organic liquid. Also provided are curable film-forming compositions containing sols of particles prepared by the methods of the present invention.

### FIELD OF THE INVENTION

The present invention relates to organic sols of colloidal particles, in particular, organic sols which are prepared from aqueous dispersions, and methods of preparing them. The invention further relates to curable film-forming compositions containing the sols.

### BACKGROUND OF THE INVENTION

Colloidal dispersions are used in coatings inter alia to improve mar and scratch resistance, to improve storage stability of the coating compositions, to assist in rheology control of coatings during application to a substrate, and to improve orientation of pigment particles in coatings containing metallic and other effect pigments. The favorable effects of the colloidal particles are due in large part to the very small size of the dispersed particles, which is less than the wavelength of light. This very small particle size can prevent the particles from scattering light, thereby preventing haziness and adverse color effects that can occur from light scattering in an applied coating. The small particle size also can promote stability of the colloidal dispersions as well as the stability of the coating compositions that contain such dispersions.

Some very small particles, for example silica particles, can associate with one another, forming agglomerates which effectively act as large particles in coatings. Therefore, some of the above-mentioned benefits of the small particle size may be lost. Water molecules in an aqueous carrier successfully compete with the neighboring particles for interaction with the polar groups. Although the stability of the suspension can be affected by factors such as pH and the presence of cations, particularly polyvalent cations, the incorporation of aqueous dispersions into aqueous coating compositions is relatively straightforward. However, in organic coatings or coatings with a high level of non-polar components, the particles have an increased tendency to agglomerate. Since many coating compositions are solventborne, it is desirable to provide a means of incorporating these colloidal dispersions of particles without agglomeration of the particles.

### SUMMARY OF THE INVENTION

A sol of particles suspended in an organic medium is provided, comprising particles that have been reacted with:

a) a first modifying compound comprising at least one group that does not react with the particles and at least one functional group capable of reacting with functional groups on the particles; and

b) a second modifying compound, wherein the second modifying compound is different from the first and comprises at least one hydrophobic group and at least one functional group capable of reacting with functional groups on the particles.

The present invention is also directed to methods of preparing a sol of particles suspended in an organic medium. The methods comprise:

a) providing a suspension of particles in an aqueous medium;

b) adding a first organic liquid compatible with the aqueous medium to form an admixture;

c) reacting the particles in the admixture with a first modifying compound, wherein the first modifying compound comprises at least one group that does not react with the particles and at least one functional group capable of reacting with functional groups on the particles;

d) reacting the particles with a second modifying compound, wherein the second modifying compound is different from the first and comprises at least one hydrophobic group and at least one functional group capable of reacting with functional groups on the particles; and

e) adding a second organic liquid compatible with the liquid portion of the admixture either before or after the particles are reacted with the second modifying compound, wherein the second organic liquid is different from the first organic liquid used in step b);

wherein when the second organic liquid is added to the admixture before the particles are reacted with the second modifying compound, the admixture is maintained at a temperature and pressure and for a time sufficient to substantially remove the water and the first organic liquid added in step b) before reacting the particles with the second modifying compound.

Film-forming compositions comprising particles prepared using the above methods are also provided by the present invention. Non-limiting embodiments comprise:

a) a film-forming resin; and

c) a sol of particles suspended in an organic medium. The sol of particles is prepared by the method described above.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The present invention is directed to a sol of particles suspended in an organic medium comprising particles that have been reacted with: (a) a first modifying compound comprising a group that does not react with the particles and a functional group capable of reacting with functional groups on the particles; and (b) a second modifying compound, wherein the second modifying compound is different from the first modifying compound, and comprises a hydrophobic group and a functional group capable of reacting with functional groups on the particles. The first and second modifying compounds are described in detail below.

In one embodiment, the present invention is directed to a method of preparing a sol of particles suspended in an organic medium comprising:

a) providing a suspension of particles in an aqueous medium;

b) adding a first organic liquid compatible with the aqueous medium to form an admixture;

c) reacting the particles in the admixture with a first modifying compound, wherein the first modifying compound comprises a group that does not react with the particles and a functional group capable of reacting with functional groups on the particles;

d) reacting the particles with a second modifying compound, wherein the second modifying compound is different from the first and comprises a hydrophobic group and a functional group capable of reacting with functional groups on the particles; and

e) adding a second organic liquid compatible with the liquid portion of the admixture either before or after the particles are reacted with the second modifying compound, wherein the second organic liquid is different from the first organic liquid used in step b);

wherein when the second organic liquid is added to the admixture before the particles are reacted with the second modifying compound, the admixture is maintained at a temperature and pressure and for a time sufficient to substantially remove the water and the first organic liquid added in step b) before reacting the particles with the second modifying compound.

In the first step of this embodiment, a suspension of particles in an aqueous medium is provided. By “aqueous medium” is meant a liquid medium that is primarily water. The aqueous medium may comprise minor amounts (i. e., up to 50 percent by weight) of other materials, either organic or inorganic, that are substantially miscible with or soluble in water. The term “suspension” or “sol” as used within the context of the present invention is believed to be a stable, two-phased translucent or opaque system in which the particles are in the dispersed phase and the aqueous medium defined above is the continuous phase. By “sol” is additionally meant a mixture of one or more types of particles in a liquid, wherein the particles are larger than individual molecules, but are small enough that, in a normal earth surface gravitational field, they remain in uniform suspension indefinitely without the application of any external mechanical, thermal, or other force. Such sols are also referred to as colloidal solutions. See, for example, page 2 of Sol-Gel Science: The Physics and Chemistry of Sol-Gel Processing, C. Jeffrey Brinker, Academic Press, 1990.

The particles can be formed from materials comprising polymeric organic materials, polymeric and nonpolymeric inorganic materials, and/or composite materials. By “polymer” is meant a polymer including homopolymers and copolymers, prepolymers, and oligomers. “Polymeric inorganic materials” include polymeric materials having backbone repeat units based on one or more elements other than carbon. By “composite material” is meant a combination of two or more differing materials. The particles formed from composite materials typically, though not necessarily, have a hardness at their surface that is different from the hardness of the internal portions of the particle beneath the surface. For example, a particle can be formed from a primary material that is coated, clad, or encapsulated with one or more secondary materials to form a composite particle that has a softer surface. In another embodiment, particles formed from composite materials can be formed from a primary material that is coated, clad, or encapsulated with a different form of the same primary material. For information on particles useful in the method of the present invention, see G. Wypych, Handbook of Fillers, 2^{nd} Ed. (1999) at pages 15-202.

The particles may comprise inorganic oxides, for example metal oxides such as zinc oxide, alumina, ceria, titania, zirconia, yttria, cesium oxide; inorganic oxides; metal nitrides such as boron nitride; metal carbides; metal sulfides such as molybdenum disulfide, tantalum disulfide, tungsten disulfide, and zinc sulfide; metal silicates including aluminum silicates and magnesium silicates such as vermiculite; metal borides; hydroxides; metal carbonates; and silica. Mixtures of such materials also can be used.

The particles can comprise, for example, a core of essentially a single inorganic oxide such as silica in colloidal, fumed or amorphous form; alumina or colloidal alumina; titanium dioxide; cesium oxide; yttrium oxide; colloidal yttria; zirconia, e. g., in colloidal or amorphous form; and mixtures of any of the foregoing; or an inorganic oxide of one type upon which is deposited an organic oxide of another type.

Other nonpolymeric inorganic materials useful in the method of the present invention include graphite, metals such as molybdenum, platinum, palladium, nickel, aluminum, zinc, tin, tungsten, copper, gold, silver, alloys, and mixtures of metals.

Organic polymeric particles are limited to those that are insoluble in and impervious to the organic liquid in which they will be dispersed. By “impervious” is meant the organic particle will not be chemically altered or will not swell due to penetration of the liquid into the polymer network.

In one embodiment of the present invention, the particles comprise silica, alumina, ceria, titania, zirconia, yttria, and/or cesium oxide. In another embodiment of the present invention, the particles comprise silica, ceria, alumina, and/or titania. In a particular embodiment of the present invention the particles comprise silica, which can be in the form of colloidal silica. The average diameter of the particles can range between 1 and 1000 nanometers prior to forming the sol, such as 5 to 250 nanometers.

The shape (or morphology) of the particles can vary depending upon the specific embodiment of the present invention and its intended application. For example, generally spherical morphologies such as solid beads, microbeads, or hollow spheres can be used, as well as particles that are cubic, platy, or acicular (elongated or fibrous). Additionally, the particles can have an internal structure that is hollow, porous, or void free, or a combination of any of the foregoing; e. g., a hollow center with porous or solid walls.

It will be recognized by those skilled in the art that mixtures of one or more types of particles and/or particles having different average particle sizes may be incorporated into the sols in accordance with the method of the present invention to impart the desired properties and characteristics to the compositions in which they are to be used.

The particles may be obtained in a dry form and dispersed into an aqueous medium by any dispersion means known to those skilled in the art. Alternatively, the particles may be obtained from a supplier already dispersed in an aqueous carrier. Examples of ready-made dispersions include the SNOWTEX® line of products available from Nissan Chemical Industries, Ltd., and NALCO 1034, available from Nalco.

The particles may have functional groups on their surface, such as, for example, hydroxyl groups, with which modifying compounds may be reacted.

Optionally, the method of the present invention further comprises a step immediately following step a) of maintaining the suspension at a temperature and pressure and for a time sufficient to remove 10 to 15 percent by weight, based on the total weight of the suspension, of volatile components in the suspension, including water.

Step (b) of the method comprises adding a first organic liquid compatible (i. e., substantially miscible) with the aqueous medium used in step (a) to form an admixture. By “compatible” is additionally meant that the organic liquid is able to come into intimate contact with the particles which are suspended in the aqueous medium and is able to at least partially replace the physical and chemical associations between the particles and the aqueous medium. The “admixture” is typically in the form of a suspension of particles in the liquid medium. The organic liquid is selected so that during subsequent distillation of the admixture, water comprises at least part of the distillate, and so that during removal of water by distillation, the particles remain dispersed and do not flocculate. The organic liquid used in step (b) may comprise glycol ethers, alcohols, esters, ketones, and/or aromatic hydrocarbons. Suitable specific examples include propylene glycol monomethyl ether, n-propanol, isopropanol, and n-butanol. In one embodiment of the present invention, the organic liquid used in step (b) comprises isopropanol. The concentration of particles in the admixture formed in step (b) can be less than or equal to 15 percent by weight, or less than or equal to 10 percent by weight, based on the total weight of the admixture.

In step (c) of the method described above, the particles are reacted with a first modifying compound, wherein the first modifying compound comprises a group that does not react with the particles and a functional group capable of reacting with functional groups on the particles. Groups that do not react with the particles may include, for example, ethylenically unsaturated groups such as vinyl, allyl, acrylate, and methacrylate groups, and the like. Functional groups capable of reacting with functional groups on the particles may include, inter alia, alkoxy groups. The first modifying compound comprises a compound having the structure:
F-L-Z
wherein F comprises a functional group that will react with the particle surface; Z comprises an unsaturated group; and L is a group that links F and Z. The Z moiety can be introduced to the particle in any manner known in the art. For example, the Z moiety may be part of a compound that, by itself, reacts with the particle, (i.e. contains an F moiety) such as a compound that contains a trialkoxy silane.

Alternatively, a compound containing a Z moiety can be reacted with another compound that contains an F moiety, either before or after the F moiety has reacted with the particle. This can be done by any means known in the art, by selecting the appropriate L moiety to bring together the F and Z moieties. For example, a trialkoxy silane wherein the fourth substituent has a first functional group can be reacted with a compound containing both a “Z” moiety and a second functional group; the first and second functional groups are selected so as to be reactive with each other. Upon reaction, the F and Z moieties are united. Any pair of functional groups can be used. For example, if one functional group is an epoxy, the other can be an amine, a carboxylic acid or a hydroxy; if one functional group is an amine, the other can be an epoxy, isocyanate or carboxylic acid; if one functional group is an isocyanate, the other can be an amine or hydroxy; and if one functional group is an acrylate, the other can be an amine.

Often the first modifying compound comprises a compound having the structure:
Si(OR)₃—(CH₂)ₙ-Z

wherein R comprises an alkyl group having 1 to 39 carbons, such as 1 or 2 carbons, Z comprises an ethylenically unsaturated group, and n is 0, 1, 2, or 3. “Alkyl” refers herein to carbon-containing groups having the specified number of carbon atoms, which groups can be cyclic or aliphatic, branched or linear, substituted or unsubstituted. Typically the first modifying compound comprises a (meth)acryloxypropyl trialkoxy silane such as acryloxypropyl trimethoxy silane. In step (d) of the method described above, the particles are reacted with a second modifying compound, wherein the second modifying compound is different from the first and comprises at least one hydrophobic group and at least one functional group capable of reacting with functional groups on the particles. As used in this context, by “hydrophobic” is meant to imply aliphatic, cycloaliphatic, aromatic, or related functionality that is generally known to be low in polarity.

The second modifying compound comprises a compound different from the first modifying compound and having the structure:
F′-L′-Z′

wherein F′ comprises a functional group that will react with the particle surface; Z′ comprises a hydrophobic group; and L′ is a group that links F′ and Z′. The Z′ moiety can be introduced to the particle in any manner known in the art as above.

In one embodiment of the present invention the second modifying compound comprises a compound having the structure:
Si(OR)₃—(CH₂)ₙ-Z′
wherein R comprises an alkyl group having 1 to 39 carbons, such as 1 or 2 carbons, Z′ comprises a hydrophobic group, e. g., a moiety that decreases the surface tension of the particle to which it is attached, and n is 0, 1 or 2. It will be appreciated that at least one of the alkoxy groups attached to the Si atom reacts with a functional group on the surface of the particle; in the case of silica particles, the alkoxy group reacts with a silanol group on the particle surface. In one embodiment, Z′ does not contain any aromaticity and in another embodiment, Z′ does not have a nitrogen group. The Z′ moiety can have no functional groups, or can have one or more functional groups. In one embodiment, two or more functional groups are present in the Z′ moiety. The functional groups, if present, can be selected, for example, based on their ability to react with a crosslinker used in a curable film-forming composition. This can provide retained mar and/or scratch resistance because the particle will covalently bond with the resin/crosslinker at the surface of the film. For certain applications, such reaction may be undesirable and the Z′ moiety does not contain any functional or reactive group.

Any Z′ moiety can be used according to the present invention, and will generally fall into one of three categories: a long chain alkyl group; a fluorocarbon-containing material; and a silane to which is attached at least two methyl groups. “Long chain” as used in this context refers to four or more carbon atoms, and a fluorocarbon-containing material refers to a material comprising at least one CF₃ group. The long chain alkyl group can be linear or branched. The Z′ moiety can be introduced to the particle in any manner known in the art. For example, the Z′ moiety may be part of a compound that, by itself, reacts with the particle such as a compound that contains a trialkoxy silane.

Examples of compounds having long alkyl chains are those wherein Z′ is —(CH₂)ₙ₁—CH₃, and n, is 1 to 30, such as 7 to 17. In this embodiment, the total of n and n, is three or greater. Specific examples include octyltrimethoxy silane, octyltriethoxy silane, and octadecyltriethoxy silane. In another particular embodiment that introduces a long alkyl chain, Z′ is 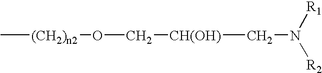
n₂ is 1 to 3 and R₁ and R₂ are the same or different and R₁ can be hydrogen or an alkyl group having 1 to 30 carbons and R₂ comprises an alkyl group having 4 to 30 carbons. For example, R₁ can be H and R₂ can be C₆H₁₃, C₈H₁₇ or C₁₂H₂₅, or both R₁ and R₂ can be (C₄H₉).

Examples of compounds having fluorocarbon-containing moieties include but are not limited to those wherein n is 1 or 2, Z′ is —(CF₂)ₘ—CF₃ and m is 0 to 30, such as 7. Perfluoro alkyl trialkoxy silanes fall within this category, such as perfluorooctyl triethoxy silane, fluoropropyltrimethoxy silane, and perfluorodecyl triethoxy silane.

Examples of compounds having dimethylsilane moieties include those wherein n is zero, Z′ is —(CH₂)ₙ₃—(Si(CH₃)₂)—O)ₘ₁—Si(CH₃)₃, n₃ is 0 to 17, such as 2, and m₁ is between 1 and 50, such as between 1 and 10. It will be appreciated that the present invention is not limited to any of the examples listed above.

Step (e) of the method of the present invention comprises adding a second organic liquid that is compatible with the liquid portion of the admixture. The second organic liquid is different from the first organic liquid used in step b). The second organic liquid may comprise glycol ethers, alcohols, esters, ketones, polymers, and/or aromatic hydrocarbons. When necessary, the second organic liquid may further comprise a dispersing aid. Suitable glycol ethers include ethylene glycol monomethyl ether, propylene glycol monomethyl ether, propylene glycol monophenyl ether, propylene glycol monoethyl ether, dipropylene glycol monomethyl ether, dipropylene glycol dimethyl ether, dipropylene glycol monobutyl ether, tripropylene glycol methyl ether, tripropylene glycol n-butyl ether, and/or tripropylene glycol t-butyl ether. Alcohols such as those listed above with respect to the first organic liquid are also suitable, as long as the one used is different from the first organic liquid. Often the second organic liquid is an alcohol, such as 2-butoxyethanol. Ketones include methylethyl ketone, methyl isobutyl ketone, methyl amyl ketone, cyclohexanone and isophorone.

The polymer that may be added as the second organic liquid can form a homogeneous mixture with other organic liquids in the admixture, while maintaining the particles in stable suspension. The polymer may comprise a polysiloxane, a polycarbonate, a polyurethane, a polyepoxide, an acrylic, a polyester, an acetoacetate, and/or a polyanhydride. The polymers may be linear, branched, dendritic, or cyclic.

In step f) of the preparation method, the admixture is maintained at a temperature for a time sufficient to substantially react the first and second modifying compounds with the functional groups on the particles. By “substantially react” is meant that at least 90 percent of a stoichiometric amount of the first and second modifying compounds react with the functional groups on the particles. The temperature may vary depending on the nature of the liquids used in the admixture.

Step g) of the method comprises an optional distillation step, wherein the admixture is maintained at a temperature and pressure and for a time sufficient to substantially remove the water and the first organic liquid added in step b). By “substantially remove” is meant that greater than 50 percent by weight of the original amounts of water and first organic liquid in the admixture are removed. Again, the temperature and pressure may vary depending on the nature of the liquids used in the admixture, but typically the admixture is maintained at a temperature of ambient to 100° C. and at a pressure of 10 mm Hg to 300 mm Hg.

In a separate non-limiting embodiment of the present invention, the method comprises:

a) providing a suspension of particles in an aqueous medium;

b) adding a first organic liquid compatible with the aqueous medium to form an admixture;

c) reacting the particles with a first modifying compound, wherein the first modifying compound comprises at least one group that does not react with the particles and at least one functional group capable of reacting with functional groups on the particles;

d) adding a second organic liquid compatible with the liquid portion of the admixture wherein the second organic liquid is different from the first organic liquid used in step b);

e) maintaining the admixture at a temperature and pressure and for a time sufficient to substantially remove the water and the first organic liquid added in step b);

f) reacting the particles with a second modifying compound wherein the second modifying compound is different from the first and comprises at least one hydrophobic group and at least one functional group capable of reacting with functional groups on the particles; and

g) maintaining the admixture at a temperature and for a time sufficient to substantially react the second modifying compound with the functional groups on the particles. Various process conditions and components used such as organic liquids, modifying compounds, etc. may be the same as those described earlier.

Note that the order of process steps for any of the embodiments of the present invention may be altered with the same results and additional steps may be added as necessary without departing from the scope of the invention. Note additionally that steps may be performed sequentially or two or more steps may be combined and performed simultaneously within the scope of the invention.

The present invention further provides film-forming compositions. These compositions comprise:

a) a film-forming resin; and

b) a sol of particles suspended in an organic medium, wherein the sol of particles is prepared by any of the methods described above.

The film-forming compositions of the present invention may be thermoplastic or thermosetting; i. e., curable at ambient temperatures, elevated temperatures, or curable via ionizing or actinic radiation. As used herein, “ionizing radiation” means high energy radiation and/or the secondary energies resulting from conversion of this electron or other particle energy to neutron or gamma radiation, said energies being at least 30,000 electron volts and can be 50,000 to 300,000 electron volts. While various types of ionizing irradiation are suitable for this purpose, such as X-ray, gamma and beta rays, the radiation produced by accelerated high energy electrons or electron beam devices also can be used. The amount of ionizing radiation in rads for curing compositions according to the present invention can vary based upon such factors as the components of the coating formulation, the thickness of the coating upon the substrate, the temperature of the coating composition and the like. Generally, a 1 mil (25 micrometer) thick wet film of a coating composition according to the present invention can be cured in the presence of oxygen through its thickness to a tack-free state upon exposure to from 0.5 to 5 megarads of ionizing radiation.

“Actinic radiation” is light with wavelengths of electromagnetic radiation ranging from the ultraviolet (“UV”) light range, through the visible light range, and into the infrared range. Actinic radiation which can be used to cure coating compositions of the present invention generally has wavelengths of electromagnetic radiation ranging from 150 to 2,000 nanometers (nm), from 180 to 1,000 nm, or from 200 to 500 nm. In one embodiment, ultraviolet radiation having a wavelength ranging from 10 to 390 nm can be used. Examples of suitable ultraviolet light sources include mercury arcs, carbon arcs, low, medium or high pressure mercury lamps, swirl-flow plasma arcs and ultraviolet light emitting diodes. Suitable ultraviolet light-emitting lamps are medium pressure mercury vapor lamps having outputs ranging from 200 to 600 watts per inch (79 to 237 watts per centimeter) across the length of the lamp tube. Generally, a 1 mil (25 micrometer) thick wet film of a coating composition according to the present invention can be cured through its thickness to a tack-free state upon exposure to actinic radiation by passing the film at a rate of 20 to 1000 feet per minute (6 to 300 meters per minute) under four medium pressure mercury vapor lamps of exposure at 200 to 1000 millijoules per square centimeter of the wet film. The film-forming compositions of the present invention may be used as automotive primers, electrodepositable primers, base coats, clear coats, and monocoats, as well as in industrial and other applications. The compositions may be easily prepared by simple mixing of the ingredients, using formulation techniques well known in the art.

The compositions of the present invention may be applied over any of a variety of substrates such as metallic, glass, wood, and/or polymeric substrates. Suitable substrates include metal substrates such as ferrous metals, zinc, copper, magnesium, aluminum, aluminum alloys, and other metal and alloy substrates typically used in the manufacture of automobile and other vehicle bodies. The ferrous metal substrates may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

The compositions of the present invention may also be applied over elastomeric or plastic substrates such as those that are found on motor vehicles. By “plastic” is meant any of the common thermoplastic or thermosetting synthetic nonconductive materials, including thermoplastic olefins such as polyethylene and polypropylene, thermoplastic urethane, polycarbonate, thermosetting sheet molding compound, reaction-injection molding compound, acrylonitrile-based materials, nylon, and the like.

The film-forming resin in the composition of the present invention may comprise a polymer having functional groups and, if appropriate, a crosslinking agent reactive with the polymer.

The crosslinking agent obviously will be selected to be reactive with the functional groups of the resin. The crosslinking agent can be any of a variety of crosslinking agents known in the art. For example, the crosslinking agent can comprise, inter alia, triazines, aminoplasts, polyisocyanates, including blocked isocyanates, polyepoxides, beta-hydroxyalkylamides, polyacids, organometallic acid-functional materials, polyamines, polyamides and mixtures of any of the foregoing. Mixtures of crosslinking agents can be used.

The film-forming resin may be any of a variety of thermosetting or thermoplastic polymers well-known in the art. In an embodiment of the invention the film-forming resin can comprise acrylic polymers, polyesters, polyurethanes, polyamides, polyethers, polysilanes, and/or silyl ether polymers. Generally these polymers can be any polymers of these types made by any method known to those skilled in the art where the polymers are water dispersible, emulsifiable, or of limited water solubility. The functional groups on the film-forming resin may be selected from carboxylic acid groups, amine groups, epoxide groups, hydroxyl groups, thiol groups, carbamate groups, amide groups, urea groups, alkoxysilane groups, and/or mercaptan groups.

Appropriate mixtures of polymeric film-forming resins may also be used in the composition of the present invention. The amount of the film-forming resin generally ranges from 25 to 95 percent by weight based on the total weight of resin solids (crosslinking agent plus film-forming resin) in the composition.

Appropriate mixtures of crosslinking agents may also be used in the composition of the present invention. The amount of the crosslinking agent generally ranges from 5 to 75 percent by weight based on the total weight of resin solids (crosslinking agent plus film-forming resin) in the composition.

The particles used in the composition of the present invention may be added to the composition neat during the formulation thereof, or they may be mixed with any of the resinous or compatible solvent components of the composition either sinigly or in any combination before incorporation into the final formulation.

The following examples are provided for illustrative purposes only. It is noted that the various polymers, additives, etc., as used in the examples are merely representative of any like components known to those skilled in the art to serve analogous roles. The components in the following examples were mixed together in the order shown:

### EXAMPLE 1

| | Parts by | Solid |
|---|---|---|
| Ingredient | weight (grams) | weights (grams) |
| Xylene | 3.86 | — |
| Ethyl-3-Ethoxypropanoate | 3.48 | — |
| Aromatic Solvent - 150 Type | 8.51 | — |
| Butyl Cellosolve ® acetate¹ | 1.82 | — |
| Odorless Mineral Spirits | 1.82 | — |
| Butyl Carbitol ®² | 2.90 | — |
| Butyl Carbitol ® acetate³ | 3.48 | — |
| Tridecyl Alcohol | 3.48 | — |
| Aromatic Solvent - 100 Type | 42.63 | — |
| TINUVIN ® 928⁴ | 2.00 | 2.00 |
| TINUVIN 292⁵ | 0.80 | 0.80 |
| TINUVIN ® 123⁶ | 0.80 | 0.80 |
| Acid catalyst⁷ | 0.69 | 0.48 |
| LUWIPAL 018⁸ | 39.7 | 29.0 |
| LAROTACT LR 9018⁹ | 9.20 | 4.60 |
| Acrylic¹⁰ | 63.5 | 41.3 |
| SETALUX C-71761 VB-60¹¹ | 41.8 | 25.1 |
| BYK337¹² | 0.10 | 0.015 |

¹2-Butoxyethyl acetate solvent is commercially available from Union Carbide Corp.
²Diethylene glycol monobutyl ether available from Union Carbide Corp.
³2-(2-Butoxyethoxy) ethyl acetate is commercially available from Union Carbide Corp.
⁴2-(2H-Benzotriazol-2yl)-6-(1-methyl-1-phenylethyl)-4-(1,1,3,3- tetramethylbutyl)phenol UV absorber available from Ciba Specialty Chemicals Corp.
⁵Sterically hindered amine light stabilizer commercially available from Ciba Additives.
⁶Bis-(1-octyloxy-2,2,6,6-tetramethyl-4-piperidinyl) sebacate hindered aminoether light stabilizer available from Ciba Additives.
⁷Dodecyl benzene sulfonic acid solution available from Chemcentral.
⁸High imino, butylated melamine formaldehyde resin commercially available from BASF Corp.
⁹Available from BASF AG.
¹⁰A polymer comprising Cardura E, styrene, hydroxyethyl methacrylate, 2-ethylhexyl acrylate, acrylic acid at a Mw of about 8000 having a hydroxy EW on solids of 370. Polymer is 65% by weight solids in Xylene/Solvesso 100 (available from Exxon) at a weight ratio of 34/66.
¹¹SCA acrylic resin solution from Akzo
¹²Solution of a polyether modified poly-dimethyl-siloxane available from BYK-Chemie.

### EXAMPLE 2

| | Parts by | Solid |
|---|---|---|
| Ingredient | weight (grams) | weights (grams) |
| Diisobutyl ketone | 17.32 | — |
| DOWANOL DPM¹ | 2.68 | — |
| Aromatic Solvent - 100 Type | 6.1 | — |
| DOWANOL PM Acetate² | 11.3 | — |
| EVERSORB 76³ | 1.12 | 1.12 |
| TINUVIN ® 328⁴ | 1.55 | 1.55 |
| Acrylic Rheology Control | 6.18 | 1.85 |
| Agent⁵ | | |
| Anti-sag Solution⁶ | 6.53 | 2.60 |
| RESIMENE 757⁷ | 41.5 | 40.27 |
| Isobutyl alcohol | 2.58 | — |
| Carbamoylated acrylic | 24.73 | 15.3 |
| polymer | | |
| Carbamoylated polyester | 54.4 | 39.4 |
| TINUVIN 292⁸ | 0.33 | 0.33 |
| Acid catalyst⁹ | 1.24 | 0.87 |

¹Dipropylene glycol monomethyl ether, available from Dow Chemical Co.
²Methyl ether propylene glycol acetate, available from Dow Chemical Co.
³Benzotriazole derivative available from Everlight Chemical Taiwan.
⁴2-(2′-Hydroxy-3′,5′-ditert-amylphenyl) benzotriazole UV light stabilizer available from Ciba Additives.
⁵A crosslinked polymeric dispersion comprising ethylene glycol dimethacrylate, styrene, butyl acrylate, and methyl methacrylate. The dispersion is 31% by weight in oxo-hexyl acetate (available from Exxon Chemicals). The number average particle size is 1000 angstroms.
⁶A dispersion containing AEROSIL R812 S silica (available from Degussa), and a polymeric component which comprises hydroxy propyl acrylate, styrene, butyl methacrylate, butyl methacrylate acrylic acid at an Mw of 7000 having a hydroxy EW on solids of 325. Polymer is 67.5% by weight solids in methyl ether of propylene glycol monoacetate/SOLVESSO 100 (available from Exxon) at a weight ratio of 60/40.
⁷Melamine formaldehyde resin commercially available from Solutia Inc.
⁸Sterically hindered amine light stabilizer commercially available from Ciba Additives.
⁹Dodecyl benzene sulfonic acid solution available from Chemcentral.

### EXAMPLE 3

| | Parts by | Solid |
|---|---|---|
| Ingredient | weight (grams) | weights (grams) |
| Ethyl-3-Ethoxypropanoate | 24.0 | — |
| DOWANOL PM Acetate¹ | 12.8 | — |
| TINUVIN ® 328² | 2.33 | 2.33 |
| TINUVIN ® 900³ | 1.16 | 1.16 |
| Acrylic⁴ | 95.3 | 66.7 |
| TINUVIN 292⁵ | 1.75 | 1.75 |

¹Methyl ether propylene glycol acetate, available from Dow Chemical Co.
²2-(2′-Hydroxy-3′,5′-ditert-amylphenyl) benzotriazole UV light stabilizer available from Ciba Additives.
³2-(2′-hydroxy-benzotriazol-2-yl)-4,6-bis(methyl-1-phenylethyl)phenol available from Ciba Additives.
⁴A polymer comprising hydroxy propyl acrylate, styrene, butyl methacrylate, butyl acrylate, acrylic acid at an Mw of about 7000 having a hydroxy EW on solids of 325. Polymer is 70% by weight solids in Xylene/SOLVESSO 100 (available from Exxon) at a weight ratio of 50/50.
⁵Sterically hindered amine light stabilizer commercially available from Ciba Additives.

### EXAMPLE 4

| | Parts by | Solid |
|---|---|---|
| Ingredient | weight (grams) | weights (grams) |
| Ethyl-3-Ethoxypropanoate | 11.0 | — |
| DESMODUR N 3390A¹ | 29.5 | 26.6 |
| DESMODUR Z 4470 SN² | 48.0 | 33.6 |

¹Polyisocyanate based on hexamethylene diisocyanate, available from Bayer Corp.
²Polyisocyanate resin solution from Bayer Corp.

### EXAMPLE 5

| | Parts by | Solid |
|---|---|---|
| Ingredient | weight (grams) | weights (grams) |
| DOWANOL DPM¹ | 12.2 | — |
| N-Pentyl Propionate | 45.0 | — |
| Isopropyl Acetate 99% | 8.9 | — |
| Epoxy Acrylic² | 49.4 | 31.6 |
| BAKELITE ERL-4221³ | 9.0 | 9.0 |
| RESIMENE R-718⁴ | 17.0 | 13.6 |
| Q-293⁵ | 0.35 | 0.35 |
| TINUVIN ® 328⁶ | 2.60 | 2.60 |
| Anhydride Copolymer⁷ | 2.74 | 2.00 |
| Acid Functional Polyester 1⁸ | 40.0 | 29.0 |
| Acid Functional Polyester 2⁹ | 10.9 | 8.70 |
| Isostearic Acid | 3.60 | 3.60 |
| Silica Grind¹⁰ | 3.01 | 1.20 |
| N,N-Dimethyl-1- | 2.00 | 2.00 |
| Aminododecane | | |

¹Dipropylene glycol monomethyl ether, available from Dow Chemical Co.
²60 gma 31 bma 7 sty 2 alpha methyl sty weight %
³Epoxy resin available from Dow Chemical Co.
⁴Melamine formaldehyde resin commercially available from Solutia Inc.
⁵Light stabilizer available from New York Fine Chemicals.
⁶2-(2′-Hydroxy-3′,5′-ditert-amylphenyl) benzotriazole UV light stabilizer available from Ciba-Geigy Corp.
⁷Copolymer of 1-octene and maleic anhydride.
⁸Copolymer of trimethylol propane (21.8 percent by weight), hexahydrophthalic anhydride (23.3 percent by weight), and methylhexahydrophthalic anhydride (54.9 percent by weight)
⁹Copolymer of 2,2-dimethyl-3-hydroxypropyl-2,2-dimethyl-3-hydroxypropanoate (38.7 percent by weight), hexahydrophthalic anhydride (18.4 percent by weight), and methylhexahydrophthalic anhydride (42.9 percent by weight)
¹⁰A dispersion of AEROSIL R812 (available from Degussa) in an acid functional resin solution.

### EXAMPLE 6

| | Parts by | Solid |
|---|---|---|
| Ingredient | weight (grams) | weights (grams) |
| Butyl Cellosolve ® acetate¹ | 22.4 | — |
| Aromatic Solvent - 150 Type | 19.0 | — |
| Xylene | 5.5 | — |
| TINUVIN ® 928² | 1.48 | 1.48 |
| TINUVIN 400³ | 1.74 | 1.48 |
| SETAMINE US146 BB 72⁴ | 41.1 | 29.6 |
| SETALUX 91795 VX-60 YB⁵ | 30.3 | 18.2 |
| TINUVIN 292⁶ | 0.78 | 0.78 |
| NACURE 5225⁷ | 2.76 | 0.69 |

¹2-Butoxyethyl acetate solvent is commercially available from Union Carbide Corp.
²2-(2H-Benzotriazol-2yl)-6-(1-methyl-1-phenylethyl)-4-(1,1,3,3-tetramethylbutyl)phenol UV absorber available from Ciba Specialty Chemicals Corp.
³Mixture of 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine UV absorber available from Ciba Specialty Chemicals Corp.
⁴Melamine formaldehyde resin available from Nuplex Reins LLC.
⁵SCA acrylic resin solution from Akzo
⁶Sterically hindered amine light stabilizer commercially available from Ciba Specialty Chemicals Corp.
⁷Blocked acid catalyst available from King Industries.

TABLE 1

| Ingredient | Example 7 | Example 8 |
|---|---|---|
| Example 1 Pre-mix | 230.57 (solids = 105.095) | 230.57 (105.095) |
| Silica A | 6.5 (1.00) | — |
| Silica B | — | 6.9 (1.00) |
| Reduction Information: | | |
| Aromatic Solvent - | 0.0 | 0.0 |
| 100 Type | | |
| Spray viscosity¹ (sec) | 28.5 | 28.1 |
| Paint temperature | 74.1 | 73.9 |
| (° F.) | | |
| Calculated % Solids² | 46 | 46 |

¹Viscosity measured in seconds with a #4 FORD efflux cup at ambient temperature.
²Calculated % Solids of a coating is determined by taking the solid weight of a specific quantity of the coating and dividing it by the solution weight.

TABLE 2

| Ingredient | Example 9 | Example 10 | Example 11 | Example 12 | Example 13 |
|---|---|---|---|---|---|
| Example 2 Pre-mix | 177.56 (103.29) | 177.56 (103.29) | 177.56 (103.29) | — | — |
| Example 3 Pre-mix | — | — | — | 137.34 (71.94) | 137.34 (71.94) |
| Example 4 Pre-mix | — | — | — | 70.7 (48.0) | 70.7 (48.0) |
| Silica A (see below) | — | 6.5 (1.00) | 6.5 (1.00) | — | 6.5 (1.00) |
| Polybutyl acrylate¹ | 0.33 (0.220) | — | — | 0.97 (0.58) | — |
| Siloxane borate² | 2.00 (1.00) | 2.00 (1.00) | — | — | — |
| DISPARLON OX-60³ | 0.20 (0.10) | — | — | — | — |
| BYK337⁴ | — | 0.10 (0.015) | 0.10 (0.015) | — | 0.10 (0.015) |
| Multiflow⁵ | — | — | — | 0.466 (0.233) | — |
| Ethyl-3-Ethoxypropanoate | — | — | — | 2.7 | — |
| Reduction Information: | | | | | |
| Diisobutyl ketone | 0.00 | 0.00 | 0.00 | — | — |
| Ethyl-3-Ethoxypropanoate | — | — | — | 15.0 | 12.6 |
| Spray viscosity⁶ (sec) | 33.8 | 29 | 29.7 | 29.1 | 28.6 |
| Paint temperature (° F.) | 72.5 | 72.3 | 71.9 | 72.8 | 72.7 |
| Calculated % Solids⁷ | 58 | 57 | 57 | 54 | 54 |

¹A flow control agent having a Mw of about 6700 and a Mn of about 2600 made in xylene at 62.5% solids available from DuPont.
²Prepared according to U.S. Pat. No. US6623791B2.,
³Additive available from King Industries.
⁴Solution of a polyether modified poly-dimethyl-siloxane available from BYK-Chemie.
⁵50% solution of MODAFLOW ®, available from Solutia Inc., supplied in xylene. MODAFLOW ® is a polymer made of 75% by weight 2-ethyl hexyl acrylate, 25% by weight ethyl acrylate with a number average molecular weight of about 7934.
⁶Viscosity measured in seconds with a #4 FORD efflux cup at ambient temperature.
⁷Calculated % Solids of a coating is determined by taking the solid weight of a specific quantity of the coating and dividing it by the solution weight.

TABLE 3

| Ingredient | Example 14 | Example 15 | Example 16 |
|---|---|---|---|
| Example 5 Pre-mix | 206.7 (103.65) | 206.7 (103.65) | 206.7 (103.65) |
| Silica C | — | 3.33 (0.50) | 3.33 (0.50) |
| Polybutyl | 0.50 (0.30) | — | — |
| acrylate¹ | | | |
| Multiflow² | 0.20 (0.10) | — | — |
| DISPARLON | 0.08 (0.04) | — | — |
| OX-60³ | | | |
| BYK337⁴ | | | 0.10 (0.015) |
| Reduction | | | |
| Information: | | | |
| N-Pentyl | 0.0 | 0.0 | 0.0 |
| Propionate | | | |
| Spray viscosity⁵ | 25 | 25 | 25 |
| (sec) | | | |
| Calculated | 50.2 | 49.6 | 49.6 |
| % Solids⁶ | | | |

¹A flow control agent having a Mw of about 6700 and a Mn of about 2600 made in xylene at 62.5% solids available from DuPont.
²50% solution of MODAFLOW ®, available from Solutia Inc., supplied in xylene. MODAFLOW ® is a polymer made of 75% by weight 2-ethyl hexyl acrylate, 25% by weight ethyl acrylate with a number average molecular weight of about 7934.
³Additive available from King Industries.
⁴Solution of a polyether modified poly-dimethyl-siloxane available from BYK-Chemie.
⁵Viscosity measured in seconds with a #4 FORD efflux cup at ambient temperature.
⁶Calculated % Solids of a coating is determined by taking the solid weight of a specific quantity of the coating and dividing it by the solution weight.

TABLE 4

| Ingredient | Example 17 | Example 18 | Example 19 | Example 20 | Example 21 | Example 22 | Example 23 |
|---|---|---|---|---|---|---|---|
| Example 6 | 125.06 (52.23) | 125.06 (52.23) | 125.06 (52.23) | 125.06 (52.23) | 125.06 (52.23) | 125.06 (52.23) | 125.06 (52.23) |
| Pre-mix | | | | | | | |
| Silica E | — | 5.8 (1.00) | — | — | — | — | — |
| Silica A | — | — | 6.5 (1.00) | 6.5 (1.00) | — | — | — |
| Silica D | — | — | — | — | 6.7 (1.00) | — | — |
| Silica B | — | — | — | — | — | 6.9 (1.00) | 6.9 (1.00) |
| CYLINK | 9.8 (4.95) | 9.8 (4.95) | 9.8 (4.95) | — | — | — | — |
| 2000¹ | | | | | | | |
| LAROTACT | — | — | — | 9.9 (4.95) | 9.9 (4.95) | 9.9 (4.95) | 9.9 (4.95) |
| LR 9018² | | | | | | | |
| Acrylic | 64.1 (46.25) | 65.5 (47.25) | 65.85 (47.25) | 65.85 (47.25) | 65.85 (47.25) | 65.59 (47.25) | 65.59 (47.25) |
| polyol | | | | | | | |
| Siloxane | 2.00 (1.00) | — | — | — | — | — | — |
| borate³ | | | | | | | |
| Aromatic | 4.0 | 3.0 | 1.00 | 1.00 | 1.00 | — | — |
| Solvent - | | | | | | | |
| 100 Type | | | | | | | |
| BYK337⁴ | 0.10 (0.015) | 0.10 (0.015) | 0.10 (0.015) | 0.10 (0.015) | 0.10 (0.015) | 0.10 (0.015) | — |
| Polybutyl | — | — | — | — | — | — | 0.50 (0.30) |
| acrylate⁵ | | | | | | | |
| Reduction | | | | | | | |
| Information: | | | | | | | |
| Aromatic | 1.53 | 0.00 | 0.00 | 0.00 | 0.00 | 3.6 | 4.4 |
| Solvent - | | | | | | | |
| 100 Type | | | | | | | |
| Spray | 33.3 | 32.4 | 34.1 | 32.9 | 33.3 | 34.6 | 34.9 |
| viscosity⁶ | | | | | | | |
| (sec) | | | | | | | |
| Paint | 73.4 | 73.6 | 72 | 73.1 | 73.0 | 72.5 | 71.9 |
| temperature | | | | | | | |
| (° F.) | | | | | | | |
| Calculated | 50.6 | 50.4 | 50.6 | 50.6 | 50.5 | 49.9 | 49.8 |
| % Solids⁷ | | | | | | | |

¹Available from Cytec Industries.
²Available from BASF AG.
³Prepared according to U.S. Pat. No. US6623791B2.
⁴Solution of a polyether modified poly-dimethyl-siloxane available from BYK-Chemie.
⁵A flow control agent having a Mw of about 6700 and a Mn of about 2600 made in xylene at 62.5% solids available from DuPont.
⁶Viscosity measured in seconds with a #4 FORD efflux cup at ambient temperature.
⁷Calculated % Solids of a coating is determined by taking the solid weight of a specific quantity of the coating and dividing it by the solution weight.

The film forming compositions of Examples 7-23 were spray applied to a pigmented base coat to form color-plus-clear composite coatings over primed electrocoated steel panels. The panels used were cold rolled steel panels (size 4 inches×12 inches (10.16 cm by 30.48 cm)). Panels for examples 7, 8, 12, 23 and 17 through 23 were coated with ED6060 electrocoat and 1177225A primer, both available from PPG Industries, Inc. The test panels are available as APR43741 from ACT Laboratories, Inc. of Hillsdale, Mich. For examples 9 through 11, panels were coated with ED6230B electrocoat and FCP6519 primer, both available from PPG Industries, Inc. Examples 9 to 11 test panels are available as APR44054 from ACT Laboratories, Inc. Panels for examples 14 through 16 were coated with ED6100H electrocoat and PCV70118 primer, both available from PPG Industries, Inc. The test panels for examples 14 to 16 are available as APR45300 from ACT Laboratories, Inc.

Examples 7, 8, 17, 18, 22 and 23 used Obsidian Schwarz, a black pigmented water-based acrylic/melamine base coat, available from PPG Industries, Inc. A black pigmented solvent-based acrylic/melamine base coat, DCT6373, available from PPG Industries, Inc. was used for examples 9 through 11. Uni-schwarz, a black pigmented water-based base coat, available from DuPont, was used for examples 12 and 13. Examples 14 through 16 used HWB-X8, a proprietary black pigmented water-based acrylic/melamine base coat. Examples 19, 20 and 21 used Royal Blue, a blue pigmented water-based acrylic/melamine base coat, available from PPG Industries, Inc.

Base coats were automated spray applied to the electrocoated and primed steel panels at ambient temperature (about 70° F. (21° C.)). A dry film thickness of about 0.4 to 0.6 mils (about 10 to 15 micrometers) was targeted for water-based base coats while 0.6 to 0.8 mils (about 15 to 20 micrometers) was targeted for the solvent-based base coats. After the base coat application, an air flash at ambient temperature was given before force flashing the water-based base coated panels. For panels base coated with HWB-X8, the force flash was ten minutes at 200° F. (93° C.) and 176° F. (80° C.) for the other water-based base coats. The panels base coated with DCT6373 were only given an air flash at ambient temperature for five minutes.

The clear coating compositions of Examples 7-23 were each automated spray applied to a base coated panel at ambient temperature in two coats with an ambient flash between applications. Clear coats for examples 7, 8 and 17 through 23 were targeted for a 1.6 to 1.8 mils (about 41 to 46 micrometers) dry film thickness. Examples 9 through 16 were targeted for a 1.8 to 2.0 mils (about 46 to 50 micrometers) dry film thickness. All coatings were allowed to air flash at ambient temperature before the oven. Panels prepared from each coating from examples 8 through 13 and 17 through 23 were baked for thirty minutes at 285° F. (141° C.) to fully cure the coating(s) while panels from examples 14 to 16 were baked at 260° F. (127° C.). The panels were baked in a horizontal position.

Properties for the coatings are reported below in Table 5.

TABLE 5

| | | | % 20° Gloss |
|---|---|---|---|
| | Initial 20° | | Retained after scratch |
| Example # | Gloss¹ | DOI² | testing³ |
| 7 | 92 | 93 | 91 |
| 8 | 92 | 94 | 91 |
| 9 | 88 | 96 | 76 |
| 10 | 87 | 96 | 94 |
| 11 | 88 | 96 | 93 |
| 12 | 86 | 97 | 14 |
| 13 | 86 | 96 | 80 |
| 14 | 86 | Not available | 47 |
| 15 | 86 | Not available | 83 |
| 16 | 86 | Not available | 86 |
| 17 | 93 | 93 | 69 |
| 18 | 93 | 95 | 76 |
| 19 | 93 | 95 | 87 |
| 20 | 93 | 94 | 90 |
| 21 | 92 | 94 | 84 |
| 22 | 92 | 94 | 91 |
| 23 | 91 | 95 | 81 |
| ¹20° gloss was measured with a Statistical Novo-Gloss 20° gloss meter, available from Paul N. Gardner Company, Inc. | | | |
| ²Distinctness-of-image (DOI) measurement was measured with a Hunter Associates Dorigon II ™ DOI meter. | | | |
| ³Coated panels were subjected to scratch testing by linearly scratching the coated surface with a weighted abrasive paper for ten double rubs using an Atlas AATCC Scratch Tester, Model CM-5, available from Atlas Electrical Devices Company of Chicago, Illinois. | | | |
| # The abrasive paper used was 3M 281Q WETORDRY ™ PRODUCTION ™ 9 micron polishing paper sheets, which are commercially available from 3M Company of St. Paul, Minnesota. Panels were then | | | |
| # wiped clean with a soft paper towel moistened with deionized water. The 20° gloss was measured (using the same gloss meter as that used for the initial 20° gloss) on the scratched area of each test panel. Using the lowest 20° gloss reading from the scratched area, | | | |
| # the scratch results are reported as the percent of the initial gloss retained after scratch testing using the following calculation: 100% * scratched gloss + initial gloss. Higher values for percent of gloss retained are desirable. | | | |

### Silica Compositions

### Silica A, Silica B, Silica C and Silica D

A 3-liter flask equipped with a stirrer, thermometer, and addition funnel is set for reflux and Charge 1 is added. The contents of the flask are then heated to reflux (95-98° C.) and the weight of water as noted in Table 6 is removed. The reactor is set for total reflux and the more concentrated dispersion is then cooled to 30-40° C. Charges 2, 3 and 4 are then added. The mixture is stirred for one hour with no additional heating. Optionally, the reaction mixture is checked to determine the % of the acryloxypropyl trimethoxysilane remaining unreacted. The flask is then configured for distillation and the indicated amount of volatiles as noted in Table 6 is removed under atmospheric distillation. Vacuum is then applied to remove additional material as noted in Table 6. The contents of the flask are then cooled to room temperature with stirring. Charges 5 and 6 are added and the mixture is heated to 80° C. for 6 hours. The final material is a fluid, translucent liquid at about 15-17% solids.

### Silica E

A 3-liter flask equipped with a stirrer, thermometer, and addition funnel is set for reflux and Charge 1 is added. The content of the flask are heated to reflux (95-98° C.) and the weight of water as noted in Table 6 is removed. The flask is then set for total reflux and the more concentrated dispersion is cooled to 30-40° C. Charges 2, 3, 4 and 5 are then added. The contents of the flask are heated to reflex (˜84° C.) and held for 3 hours. The flask is configured for distillation and the indicated amount of volatiles as noted in Table 6 is removed under atmospheric distillation. The contents of the flask are then cooled to room temperature with stirring. The final material is a fluid, translucent liquid at about 17% solids.

TABLE 6

| | | Silica A | Silica B | Silica C | Silica D | Silica E |
|---|---|---|---|---|---|---|
| Charge 1 | Snowtex O | 750.0 | 53627.3 | 750.0 | 750 | 375 |
| | Grams of Water Removed | 81.8 | 5.7 | 81.3 | 82 | 47 |
| Charge 2 | Isopropanol | 678.0 | 48500.5 | 678.0 | 678 | 677 |
| Charge 3 | Acryloxypropyltrimethoxy-silane | 37.8 | 2676.8 | 37.8 | — | 18.8 |
| | methacryloxypropyl trimethoxysilane | — | — | — | 37.5 | — |
| Charge 4 | butoxyethanol | 1500.0 | 107254.68 | 1500.0 | 1500 | 750 |
| | % residual | <0.01 | <0.01 | <0.01 | <0.01 | N/A |
| | Wgt. Removed by atmospheric distillation | 678.0 | 48092.20 | 677.1 | 682.4 | 1139 |
| | Wt. Removed by vacuum distillation | 854.0 | 63518.00 | 852.0 | 857 | — |
| Charge 5 | octyltriethoxysilane [OTES] | 7.5 | 536.3 | 7.5 | 7.5 | 3.75 |
| Charge 6 | Dibutyltindilaurate (DBTDL) | 1.5 | 107.3 | 1.5 | 1.5 | — |
| | Final % Solids | 15.3 | 16.4 | 14.5 | 14.9 | 17.2 |
| | Final % Water | 0.037 | 0.0564 | 0.038 | 0.038 | 0.027 |

Whereas particular embodiments of this invention have been described above for purposes of illustration, it will be evident to those skilled in the art that numerous variations of the details of the present invention may be made without departing from the scope of the invention as defined in the appended claims.

Therefore, what is claimed is:

1. A sol of particles suspended in an organic medium comprising particles that have been reacted with:
a) a first modifying compound comprising a group that does not react with the particles and a functional group capable of reacting with functional groups on the particles; and
b) a second modifying compound, wherein the second modifying compound is different from the first and comprises a hydrophobic group and a functional group capable of reacting with functional groups on the particles.

2. The sol of claim 1, wherein the first modifying compound comprises a compound having the structure:
F-L-Z
wherein F comprises a functional group that will react with the particle surface; Z comprises an unsaturated group; and L is a group that links F and Z.

3. The sol of claim 1, wherein the second modifying compound comprises a compound having the structure:
F′-L′-Z′
wherein F′ comprises a functional group that will react with the particle surface; Z′ comprises a hydrophobic group; and L′ is a group that links F′ and Z′.

4. A method of preparing a sol of particles suspended in an organic medium comprising:
a) providing a suspension of particles in an aqueous medium;
b) adding a first organic liquid compatible with the aqueous medium to form an admixture;
c) reacting the particles in the admixture with a first modifying compound, wherein the first modifying compound comprises a group that does not react with the particles and a functional group capable of reacting with functional groups on the particles;
d) reacting the particles with a second modifying compound, wherein the second modifying compound is different from the first and comprises a hydrophobic group and a functional group capable of reacting with functional groups on the particles; and
e) adding a second organic liquid compatible with the liquid portion of the admixture either before or after the particles are reacted with the second modifying compound, wherein the second organic liquid is different from the first organic liquid used in step b);
wherein when the second organic liquid is added to the admixture before the particles are reacted with the second modifying compound, the admixture is maintained at a temperature and pressure and for a time sufficient to substantially remove the water and the first organic liquid added in step b) before reacting the particles with the second modifying compound.

5. The method of claim 4, wherein the particles are present in the admixture formed in step b) at a concentration of less than or equal to 10 percent by weight based on the total weight of the admixture.

6. The method of claim 4, wherein the hydrophobic group on the second modifying compound decreases the surface tension of the particle after reaction of the second modifying compound with the particle.

7. The method of claim 4, wherein the particles comprise silica, ceria, alumina, and/or titania.

8. The method of claim 4, wherein the average diameter of the particles is between 1 and 1000 nanometers prior to forming the sol.

9. The method of claim 4, wherein the first organic liquid comprises an alcohol.

10. The method of claim 4, wherein the first modifying compound comprises a compound having the structure:
F-L-Z
wherein F comprises a functional group; Z comprises an unsaturated group; and L is a group that links F and Z.

11. The method of claim 10, wherein the first modifying compound comprises acryloxypropyl trimethoxy silane.

12. The method of claim 4, wherein the second modifying compound comprises a compound having the structure:
F′-L′-Z′
wherein F′ comprises a functional group; Z′ comprises a hydrophobic group; and L′ is a group that links F′ and Z′.

13. The method of claim 12, wherein Z′ comprises a long chain alkyl group.

14. The method of claim 12, wherein Z′ comprises a fluorocarbon.

15. The method of claim 12, wherein Z′ comprises a silane to which is attached at least two methyl groups.

16. The method of claim 4, wherein the second organic liquid comprises an ester.

17. A film-forming composition comprising:
a) a film-forming resin ; and
b) a sol of particles suspended in an organic medium, wherein said sol of particles is prepared by the method of claim 4.

18. The composition according to claim 17, wherein the film-forming resin comprises a polymer having functional groups and a crosslinking agent reactive with the polymer.

19. The composition of claim 17, wherein the particles comprise silica, ceria, alumina, and/or titania.

20. The composition of claim 17, wherein the average diameter of the particles is between 1 and 1000 nanometers prior to forming the sol.
